(19) United States
(12) Patent Application Publication
(10) Pub. No.: US 2003/0116234 A1
(43) Pub. Date: Jun. 26, 2003

(54) Consumable welding filler metal for cladding alloys

(76) Inventors: Michael L. Santella, Knoxville, TN (US); Craig A. Blue, Knoxville, TN (US); Jeffrey D. McNabb, Lenoir City, TN (US); Vinod K. Sikka, Oak Ridge, TN (US)

Correspondence Address: UT-Battelle, LLC, 111 Union Valley Rd., PO Box 2008, Mail Stop 6498, Oak Ridge, TN, 37831, US

(21) Appl. No.: 10/023,885

(22) Filed: Dec. 21, 2001

(51) Int. Cl. C22C 21/00; B23K 35/34

(52) U.S. Cl. 148/437

(57) ABSTRACT

A consumable welding filler material for cladding alloys includes a ductile metal and an alloying element in appropriate ratio to produce a hypereutectic during a welding process. In one embodiment, a consumable welding filler material for cladding alloys includes a metal sheath, which includes aluminum, and an inner core material, which includes silicon in an amount of greater than 12.6 wt. % so that a hypereutectic is produced when the consumable welding filler material is melted during a welding process.

### CROSS-REFERENCE TO RELATED APPLICATIONS

This application is related to another application filed on even date herewith and entitled “ALUMINUM ALLOYS HAVING IMPROVED SURFACE PROPERTIES AND METHOD OF MAKING SAME”, Docket No. 0798.0, the entire disclosure of which is incorporated herein by reference.

The United States Government has rights in this invention pursuant to contract no. DE-AC05-000R22725 between the United States Department of Energy and UT-Battelle, LLC.

### FIELD OF THE INVENTION

The present invention relates to welding filler materials for surface treatments for aluminum alloys, and more particularly to welding filler materials that produce hypereutectic claddings during welding processes.

### BACKGROUND OF THE INVENTION

Because of decreased weight and advantageous mechanical properties, aluminum alloys are rapidly displacing iron and steel alloys in many industrial and commercial applications. For example, automotive manufacturers utilize aluminum alloys for components that were formerly manufactured using iron or steel alloys to decrease vehicle weight while maintaining the structural integrity of the vehicle. Generally speaking, the lighter the vehicle, the greater its fuel efficiency.

Unfortunately, components manufactured from aluminum alloys do not share all of the desirable mechanical properties of comparable components manufactured from iron or steel alloys. The abrasion, wear, and corrosion characteristics of iron or steel alloys are generally considered superior to those exhibited by aluminum alloys. If a cost effective way to improve the abrasion, wear, and corrosion characteristics of aluminum alloys could be developed, more aluminum alloys would be used in automotive and other appropriate applications. The result could yield even greater increases in vehicle fuel efficiency that could benefit society fiscally and environmentally.

One of the most common ways to improve the abrasion, wear, and corrosion characteristics of aluminum alloys is to increase silicon content. Consistent with phase diagrams known to one of ordinary skill in the art, aluminum-silicon alloys form a eutectic when silicon concentrations are approximately 12.6 wt. % silicon. Hypereutectic aluminum alloys, i.e., aluminum alloys having a silicon concentration in excess of 12.6 wt. % silicon, generally have large silicon particles that are very hard. The large silicon particles generally make hypereutectic aluminum alloys more wear resistant than non-eutectic or eutectic aluminum alloys. A common hypereutectic aluminum alloy is Al-390, or alloy 390, which contains approximately 16 to 18 wt. % silicon. Unfortunately, hypereutectic aluminum alloys are generally more difficult to cast and machine. Additionally, increasing silicon concentrations generally has a detrimental effect on the mechanical properties, e.g., ductility, of aluminum alloys.

Using surface technology to locally increase the silicon concentration of aluminum alloys is one alternative for improving the abrasion, wear, and corrosion resistance characteristics of a manufactured component while maintaining the desirable mechanical properties of its underlying aluminum alloy substrate. Generally, surface layers having high silicon concentrations are produced by depositing silicon or mixtures containing high silicon concentrations onto aluminum alloys and then melting the silicon mixture into the surface of the aluminum alloys by application of heat. Surface heating of silicon-coated aluminum alloys may be accomplished by laser beam processing or infrared heating. Although these heating techniques are effective, they rely on relatively sophisticated and expensive equipment that is usually difficult to use in normal manufacturing situations.

### OBJECTS OF THE INVENTION

Accordingly, it is an object of the present invention to provide a means of producing aluminum alloy components that have abrasion, wear, and corrosion resistance characteristics similar to those exhibited by hypereutectic alloys.

It is another object of the present invention to provide a process for improving the abrasion, wear, and corrosion characteristics of aluminum alloys that utilizes conventional welding techniques.

It is another object of the present invention to overcome the difficulties encountered in the art by using a welding process to apply a cladding layer to the surface of an aluminum alloy for the purpose of improving the abrasion, wear, and corrosion characteristics of the aluminum alloy.

Further objects, benefits, and features of the present invention will become apparent to one of ordinary skill in the art from the drawings and description of the preferred embodiments claimed and disclosed herein.

### SUMMARY OF THE INVENTION

In accordance with one aspect of the present invention, the foregoing and other objects are achieved by a consumable welding filler material for cladding alloys includes a ductile metal and an alloying element in appropriate ratio to produce a hypereutectic during a welding process.

In accordance with another aspect of the present invention, a consumable welding filler material for cladding alloys includes a metal sheath, which includes aluminum, and an inner core material, which includes silicon in an amount of greater than 12.6 wt. % so that a hypereutectic is produced when the consumable welding filler material is melted during a welding process.

### BRIEF DESCRIPTION OF THE DRAWINGS

FIG. 1 is a perspective cutaway of a consumable welding rod showing the outer layer and the inner core material in accordance with the present invention.

FIG. 2 is a photograph of an aluminum alloy 319 casting including machined overlay cladding layers on opposing sides in accordance with the present invention.

FIG. 3 is a photomicrograph of an overlay cladding layer from the casting shown in FIG. 2.

For a better understanding of the present invention, together with other and further objects, advantages and capabilities thereof, reference is made to the following disclosure and appended claims in connection with the above-described drawings.

### DETAILED DESCRIPTION OF THE INVENTION

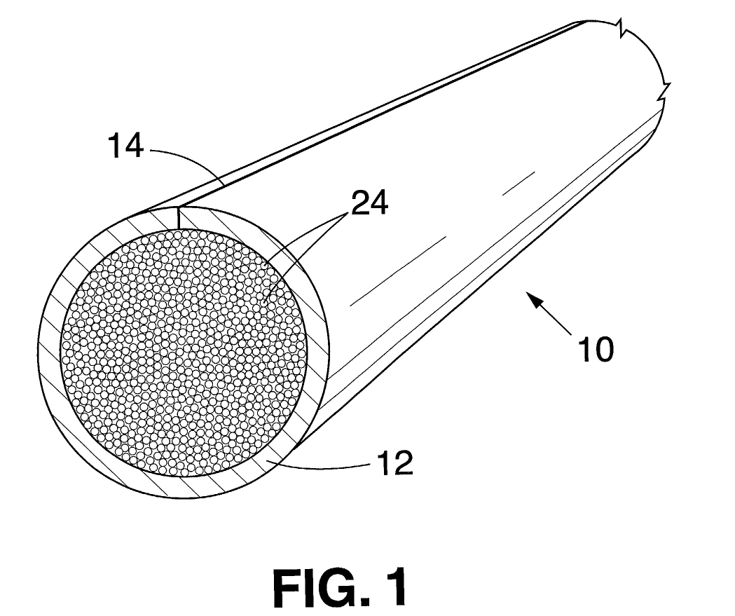

Referring to FIG. 1, certain embodiments of the invention are described as follows. A weld overlay material (filler metal) in the form of a consumable welding rod (or wire) 10 is shown that is used to apply a hypereutectic cladding layer to a surface of an aluminum alloy component or casting. The welding rod is preferably comprised of a ductile metal sheath 12, or outer layer, surrounding an alloying element, or inner core material 16. The outer layer 12 may be fabricated from any commercially available aluminum material, e.g., aluminum alloy 1100, and formed into any geometry to encapsulate the inner core material. Preferably, but not necessarily, the outer layer is conformed to a substantially annular or circular cross-sectional geometry. Although the examples discussed herein teach the use of aluminum and aluminum alloys for the outer layer 12 of the consumable welding rod, one of ordinary skill in the art will recognize that combinations and alloys of nickel, iron, molybdenum, titanium, magnesium, and stainless steel may also be used.

For alloys comprised of at least 50% aluminum, any of the alloys having properties as listed in Table I may be used for the outer layer 12 of the consumable welding rod. The term “XYZ” indicates a plurality of alloys that are within the well-known family of alloys denoted by the leading number identified in Table I.

TABLE I

| Alloy | Property |
|---|---|
| 1XYZ | Controlled unalloyed (pure) compositions |
| 2XYZ | Where Cu is the principle alloying element |
| 3XYZ | Where Mn is the principle alloying element |
| 4XYZ | Where Si is the principle alloying element |
| 5XYZ | Where Mg is the principle alloying element |
| 6XYZ | Where Mg and Si are the principle alloying elements |
| 7XYZ | Where Zn is the principle alloying element |
| 8XYZ | Miscellaneous alloys and alloys containing Sn and Li. |

The inner core material 16 is preferably comprised of silicon in at least one of a solid, liquefied, granular, powder, or gelatinous state. The amount of silicon should be selected to produce a consumable welding rod having greater than 12.6 wt. % silicon in order to produce a hypereutectic during the welding process. Although silicon is taught herein as the preferred alloying element comprising the inner core material 16 of the consumable welding rod, one of ordinary skill in the art will recognize that combinations and alloys of boron, cobalt, chromium, copper, iron, magnesium, molybdenum, nickel, niobium, phosphorus, titanium, vanadium, tungsten, zirconium, carbon, nitrogen, and oxygen may also be used in appropriate ratio to produce a hypereutectic during the welding process. It is preferable to use the smallest particle size that can be used without the occurrence of agglomeration.

The consumable welding rod 10 may be fabricated by utilizing any of a variety of well-known, conventional methods, some of which will result in features such as a seam 14 where the outer layer 12 is joined. For example, a ductile alloy tube can be used to form an outer layer 12 for containing inner core material 16. Alloy tubes having various dimensions may be used as long as the ratio of outer layer material 12 to inner core material 16 is appropriate to produce a hypereutectic during the welding process.

### EXAMPLE I

A high-purity commercial grade aluminum alloy 1100 tube having an initial size of approximately 19 inches long, 0.25 inches outside diameter, and 0.03 inches wall thickness was closed on one end and then filled with pure silicon powder having an approximate grain size of about 100 mesh. After the tube was substantially filled with silicon, the open end of the tube was closed to seal the opening and entrap the silicon in the tube cavity. Once sealed, the tube containing the silicon powder was cold swaged into a wire having an approximate outside diameter of 0.12 inches.

Conventional production methods can be used to produce consumable welding rods consistent with the present invention in mass-manufacturing environments. For example, silicon inner core material can be deposited on a planar surface of a thin sheet of aluminum alloy, which is then molded to surround the inner core material. Once the aluminum alloy is formed to surround the inner core material, the preformed wire may then be cold swaged into a wire with a desired outer diameter. The preformed wire may be formed from long pieces of sheet aluminum to allow a substantially continuous feed into the cold swage process. The continuous cold swaged wires may then be cut into consumable welding rods having preselected lengths. The ends of the consumable welding rods may be sealed contemporaneously with the cutting process or in a separate step using conventional sealing techniques known to one of ordinary skill in the art.

Once a consumable welding rod having the appropriate content is obtained, the surface properties of an aluminum alloy casting may be improved by depositing the consumable welding rod on the surface of the casting using welding processes. Although the instant example describes the use of castings comprised of noneutectic aluminum alloys, one of ordinary skill in the art will appreciate that the process may be applied to castings comprised of eutectic aluminum alloys as well. The consumable welding rod is fused to any surface of the casting using manual or automated welding techniques to produce hypereutectic layers on eutectic and noneutectic casting substrates.

Examples of welding processes that are suitable for fusing the consumable welding rod to the casting substrate include gas-tungsten-arc (GTA), gas metal-arc (GMA), plasma arc (PA), and laser beam (LB) welding processes. One of ordinary skill in the art will recognize that other conventional, well known aluminum welding processes may be used to fuse the consumable welding rod to the aluminum casting.

The weld overlay may be deposited in any geometry or pattern, e.g., horizontal lines, vertical lines, circles, nonlinear lines, etc., that will be accepted by the surface of the casting. Regardless of the welding process and deposit pattern used, the weld overlay deposit should be free of cracks and should have minor porosity of the type normally associated with aluminum casting welds. Once the overlay is deposited on the casting, it may be machined to conform to a predetermined shape or design.

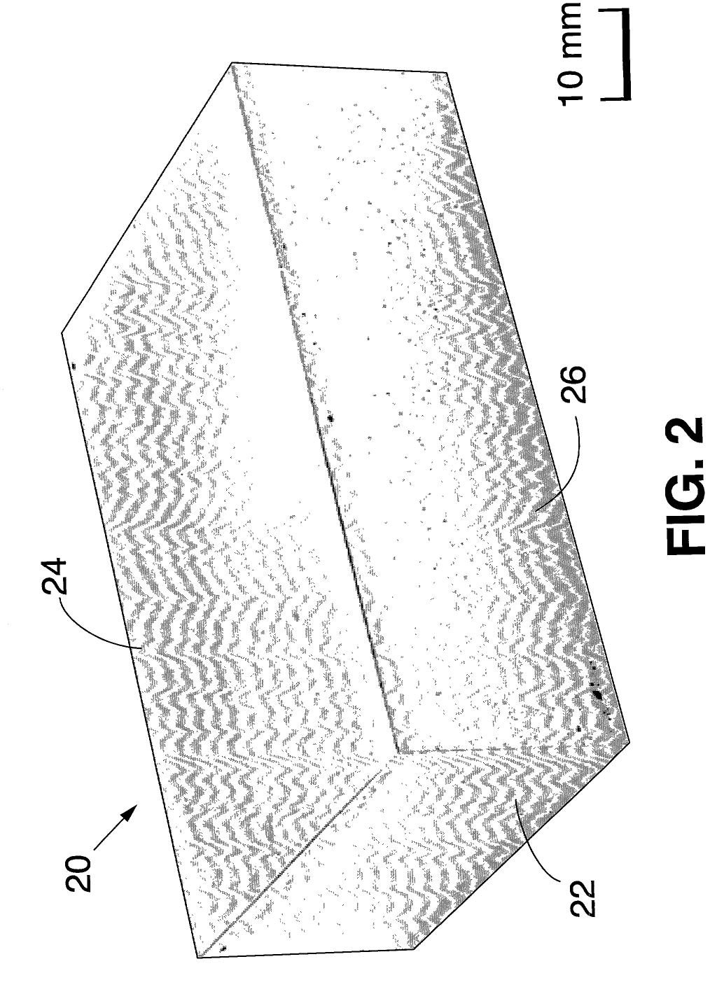

FIG. 2 shows a machined block of an aluminum 319 casting 26 with a machined hypereutectic overlay 24 on two of opposing sides thereof. The weld-casting interfaces 22 can be clearly seen.

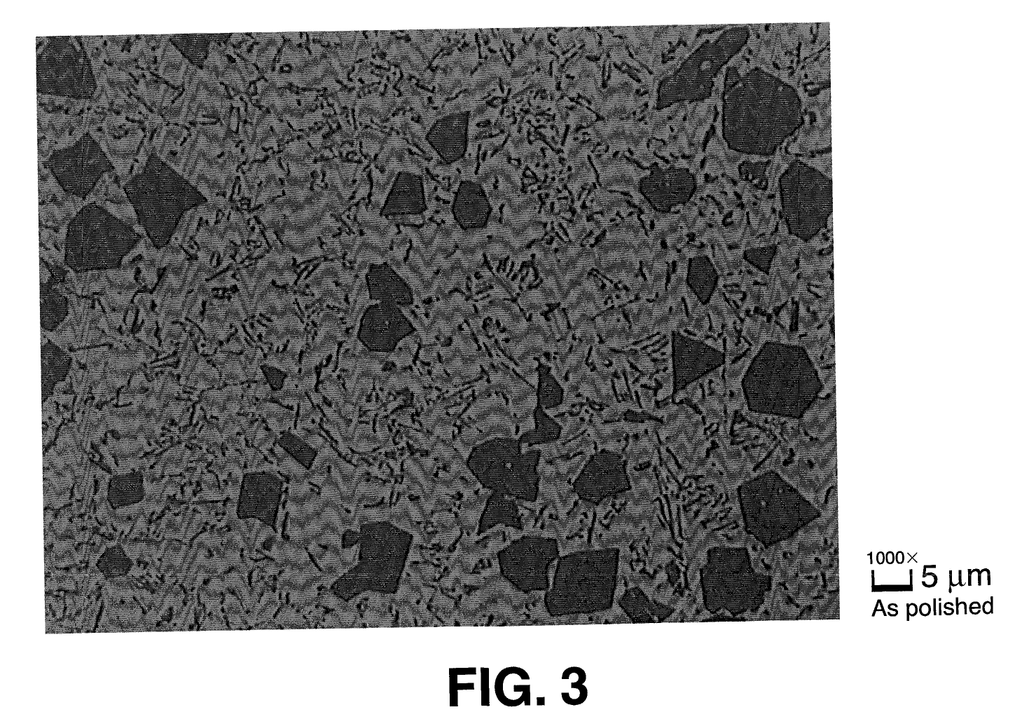

FIG. 3 is a photomicrograph of the hypereutectic overlay revealing the relatively large silicon particles in the overlay. The microstructure shown is comparable to that of aluminum alloy 390, suggesting that the abrasion, wear, and corrosion properties of the castings are similar to those of aluminum alloy 390. Testing revealed that the hardness of the overlay layer was 117 dph, which is comparable to the 124 dph hardness value of aluminum alloy 390.

While there has been shown and described what are at present considered the preferred embodiments of the invention, it will be obvious to those skilled in the art that various changes and modifications can be prepared therein without departing from the scope of the inventions defined by the appended claims.

What is claimed is:

1. A consumable welding filler material for cladding alloys comprising a ductile metal and an alloying element in appropriate ratio to produce a hypereutectic during a welding process.

2. A consumable welding filler material in accordance with claim 1 wherein said ductile metal comprises at least one of the group consisting of aluminum, nickel, iron, molybdenum, titanium, magnesium, stainless steel, and alloys of any of the foregoing.

3. A consumable welding filler material in accordance with claim 2 wherein said ductile metal comprises at least 50% aluminum.

4. A consumable welding filler material in accordance with claim 1 wherein said ductile metal further comprises a sheath which at least partially encapsulates said alloying element.

5. A consumable welding filler material in accordance with claim 4 wherein said alloying element is in a state of at least one the group consisting of a solid, liquid, granular, powder, and gelatinous.

6. A consumable welding filler material in accordance with claim 4 wherein said alloying element is selected from the group consisting of boron, cobalt, chromium, copper, iron, magnesium, molybdenum, nickel, niobium, phosphorus, silicon, titanium, vanadium, tungsten, zirconium, carbon, nitrogen, and oxygen.

7. A consumable welding filler material in accordance with claim 6 wherein said alloying element comprises at least one oxide.

8. A consumable welding filler material in accordance with claim 6 wherein said alloying element comprises at least one carbide.

9. A consumable welding filler material in accordance with claim 6 wherein said alloying element comprises at least one intermetallic compound.

10. A consumable welding filler material in accordance with claim 6 wherein said alloying element comprises at least one nitride.

11. A consumable welding filler material for cladding alloys comprising:
a. a metal sheath comprising aluminum; and
b. an inner core material comprising silicon in an amount of greater than 12.6 wt. % so that a hypereutectic is produced when said consumable welding filler material is melted during a welding process.
